(19) United States
(12) Patent Application Publication
(10) Pub. No.: US 2008/0121218 A1
(43) Pub. Date: May 29, 2008

(54) Electric turbocompound control system

(75) Inventor: Marcelo C. Algrain, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/641,778

(22) Filed: Dec. 20, 2006

Related U.S. Application Data
(63) Continuation-in-part of application No. 11/010,958, filed on Dec. 13, 2004, now Pat. No. 7,174,714.

(51) Int. Cl. F02B 33/00; F02B 33/44

(52) U.S. Cl. 123/565; 60/612; 60/605.1

(57) ABSTRACT

A turbocompound system for an engine is disclosed. The system includes at least one turbocharger. At least one first electric machine is rotatably coupled to the at least one turbocharger, and a second electric machine is rotatably coupled to the engine. The system further includes a control system configured to enable recovery of energy through operation of the at least one first electric machine and the second electric machine.

This application is a continuation-in-part of U.S. patent application Ser. No. 11/010,958, filed Dec. 13, 2004, the entire contents of which are hereby incorporated by reference.

### TECHNICAL FIELD

The present disclosure relates to an electric turbocompound system of an engine, and more particularly relates to controlling the electrical power consumed and produced by the electric turbocompound system.

### BACKGROUND

A turbocompound system of an engine assists the engine by putting mechanical power into the crankshaft of the engine. The mechanical power is developed through an electric machine that acts as a motor and is connected to the crankshaft. The electrical power that drives the motor is produced by another electric machine that is associated with a turbocharger and that acts as a generator. Typically, this generator operates as such by rotation of the turbocharger shaft, and the turbocharger shaft rotates in response to exhaust gases from the engine that turn a turbine. While the principal purpose of the turbocharger is to compress gases with a compressor for introduction into the engine cylinders (called “boost”), the turbocompound system provides an additional mechanism to recover energy that might otherwise be lost where the energy in the exhaust gases exceeds what is needed to drive the compressor.

A turbocompound system can also provide other advantages. The electric machine associated with the turbocharger may also act as a motor instead of a generator in certain instances, and the electric machine associated with the engine crankshaft may likewise operate as a generator. In instances where the turbine cannot provide sufficient mechanical power to drive the compressor to meet the needs of the engine, the engine crankshaft may drive its associated electric device as a generator. Power from the generator will drive the electric machine on the turbocharger shaft as a motor, thus providing additional energy to drive the compressor and increase the compressed air flowing to the engine.

Increasingly, it is desirable to better control engine operating parameters in order to balance fuel efficiency, engine emissions control, and engine power requirements. To that end, some engines may employ such expedients as multiple turbochargers with associated cooling units, variable valve timing responsive to engine load with, for example, the capability of achieving very early or very late intake valve closing, and multi-stage fuel injection. Other expedients may include controlled recirculation of exhaust gases, including low pressure exhaust gas recirculation (low pressure EGR), and mixing fuel and air upstream of any pre-compression to create a more homogeneous charge. One or more of these expedients, along with turbocompounding, may assist in better controlling engine operating parameters and achieving a desired balance of fuel efficiency, engine emissions control, and engine power requirements.

While the adaptability of such a turbocompound system is apparent, the control of the system itself is critical to its capability to recover energy from exhaust gases that would otherwise be lost, to improve engine response under various conditions, and/or to fulfill other purposes such as driving additional electrical devices. At the same time, these opportunities must be carefully managed, so that overall system efficiency is achieved.

An example of one turbocompounding system is in U.S. Pat. No. 5,678,407 issued to Hara on Oct. 21, 1997. The system disclosed in the Hara patent uses calculated and actual engine values to determine whether the engine and the turbocharger mounted generator/motor are under certain conditions. Depending upon the condition, the generator/motor may be shifted from the generator mode to the motor mode or vice versa. The control system is designed to prevent abrupt mode changes, avoiding consequent abrupt load changes on the engine for smooth operation.

While the disclosure of the Hara patent affects the control of the engine, the aspect of control is directed to the acceleration mode of the engine. Other considerations and engine parameters are important to improve overall system efficiency, providing a control system that can maximize gains in efficiency. Furthermore, the Hara patent does not recognize the energy recovery capabilities, overall efficiency, and increased engine flexibility that may be achieved by employing additional features such as Miller Cycle operation, multiple stage pressurization of intake air, and variable valve timing, for example.

U.S. Pat. No. 3,257,797 issued to Lieberherr on Jun. 28, 1966 discloses, in FIG. 1 thereof, an engine including at least two stages of turbocharging (20, 16) with a cooling stage (22) between the compressor units of the two turbochargers and a second cooling stage (24) between the second compressor unit and the engine. Along with this, Lieberherr discloses a variable intake valve closing system and, while not using the term “Miller Cycle,” Lieberherr discloses using variable valve timing to close the inlet valve early, during the suction (i.e., intake) stroke of the piston, or late, during the compression stroke of the piston (which maintains the intake valve open for a portion of the compression stroke), in order to reduce the effective compression ratio (col. 6, lines 57-63). Additionally, Lieberherr discloses that reducing the effective compression ratio occurs with increasing engine load (col. 10, lines 17-24).

While the disclosure of the Lieberherr patent recognizes a number of important expedients, such as, dual stage turbocharging, late intake valve closing to maintain the intake valve open for a portion of the compression stroke to yield a reduced effective compression ratio at high engine loads, and variable valve timing, Leiberherr does not recognize the advantages of turbo compounding.

U.S. Pat. No. 2,670,595 issued to Miller on Mar. 2, 1954. This Miller patent (U.S. Pat. No. 2,670,595), in FIG. 6, for example, discloses an engine including a turbocharger (52, 55) for pressurizing intake air and a cooler (58) between the turbocharger and the engine. Additionally, Miller discloses a variable intake valve closing system (FIG. 6; col. 9, line 23 through col. 10, line 21), and discloses a specific example of closing the intake valve early during the intake stroke at about 60° after top dead center (e.g., col. 6, lines 64-69). Miller also specifically discloses varying the effective compression ratio in consonance with load by holding the intake valve open during the entire intake stroke and during a part of the following compression stroke (col. 8, lines 14-23) (i.e., late closing of the intake valve).

While the disclosure of the Miller patent (U.S. Pat. No. 2,670,595) recognizes a number of important expedients, such as, pressurizing and cooling the intake air, variable intake valve timing, and both very early intake valve closing and late intake valve closing to vary the effective compression ratio in consonance with load, the Miller patent does not recognize the advantages of turbocompounding.

U.S. Pat. No. 3,015,934 issued to Miller on Jan. 9, 1962. The Miller '934 patent discloses, in FIG. 1 thereof, an engine including a turbocharger (28) for pressurizing intake air and a cooler (36) between the turbocharger and the engine. Additionally, the Miller '934 patent discloses a variable intake valve closing system (FIG. 2), and discloses a specific example of late closing of the intake valve during the compression stroke, at 60 or 70 degrees before top dead center (col. 2, lines 31-33), reducing the effective compression ratio.

While the Miller '934 patent recognizes a number of important expedients, such as, pressurizing and cooling the intake air, variable valve timing, and maintaining the intake valve open during a majority portion of the compression stroke to as much as 60 or 70 degrees before top dead center in the compression stroke, the Miller '934 patent does not recognize the advantages of turbo compounding.

The disclosed embodiments are directed to overcoming one or more of the limitations discussed above.

### SUMMARY OF THE INVENTION

In one aspect, a turbocompound system for an engine has at least one turbocharger, at least one first electric machine rotatably coupled to the at least one turbocharger, and a second electric machine rotatably coupled to the engine. A control system is configured to enable recovery of energy through operation of the at least one first electric machine and the second electrical machine.

Another aspect involves a method of operating a turbocompound system for an engine having at least one turbocharger. The system has at least one first electric machine generating electrical power in response to rotation of the at least one turbocharger. A second electric machine drives the engine in response to electrical power generated by the at least one first electric machine. An electrical bus connects the at least one first electric machine and the second electric machine. The method comprises controlling operating of the turbocompound system to enable recovery of energy through operation of the at least one first electric machine and the second electric machine.

### BRIEF DESCRIPTION OF THE DRAWINGS

FIG. 1 is a diagrammatic view of an exemplary system for turbocompounding of an engine;

FIG. 2 is a graph of a simulation illustrating an operating envelope for a turbocharger that may be used with a turbocompounding system;

FIG. 3 is a graph of a simulation illustrating four different engine operating conditions and related changes in brake specific fuel consumption based upon recovering power through a turbocharger assisting the engine;

FIG. 4 illustrates optimum operating points for different engine load conditions and the value of selected variables at the points;

FIG. 5 illustrates the time response for a ten percent step change in engine demand;

FIG. 6 illustrates the simulated change in engine exhaust temperature in response to the change in demand illustrated by FIG. 5;

FIG. 7 illustrates the simulated change in crankshaft torque in response to the change in demand illustrated by FIG. 5;

FIG. 8 illustrates the response to a step change in engine load from twenty-five percent (25%) to fifty percent (50%);

FIG. 9 illustrates the simulated change in turbocharger speed through simulation in response to the step change in engine load illustrated by FIG. 8, and the expected change in speed as represented by a set point trace;

FIG. 10 illustrates the simulated change in crankshaft torque in response to the step change in engine load illustrated by FIG. 8;

FIG. 11 illustrates step changes in engine load corresponding to ten percent (10%) changes in engine load;

FIG. 12 illustrates the simulated change in intake pressure or engine boost in response to the step change in engine load illustrated by FIG. 11;

FIG. 13 illustrates the simulated change in crankshaft torque in response to the step change in engine load illustrated by FIG. 11;

FIG. 14 illustrates an engine boost set point map where boost values are plotted against engine speed and load;

FIG. 15 illustrates the time response to step changes in engine load or demand;

FIG. 16 illustrates the simulated changes in intake pressure or boost in response to the change in engine load illustrated by FIG. 15, and the expected change illustrated by a set point trace;

FIG. 17 illustrates the simulated changes in crankshaft torque in response to the change in engine load illustrated by FIG. 15;

FIG. 18 illustrates features of one embodiment of a control system associated with an engine;

FIG. 19 illustrates features of a motor controller and generator controller associated with a control system and engine;

FIG. 20 illustrates an exemplary engine cylinder and related engine components;

FIG. 21 is a graph illustrating an exemplary intake valve operation as a function of engine crank angle in accordance with the present disclosure; and

FIG. 22 is a diagrammatic view of an exemplary system for turbo-compounding of an engine including plural turbochargers.

### DETAILED DESCRIPTION

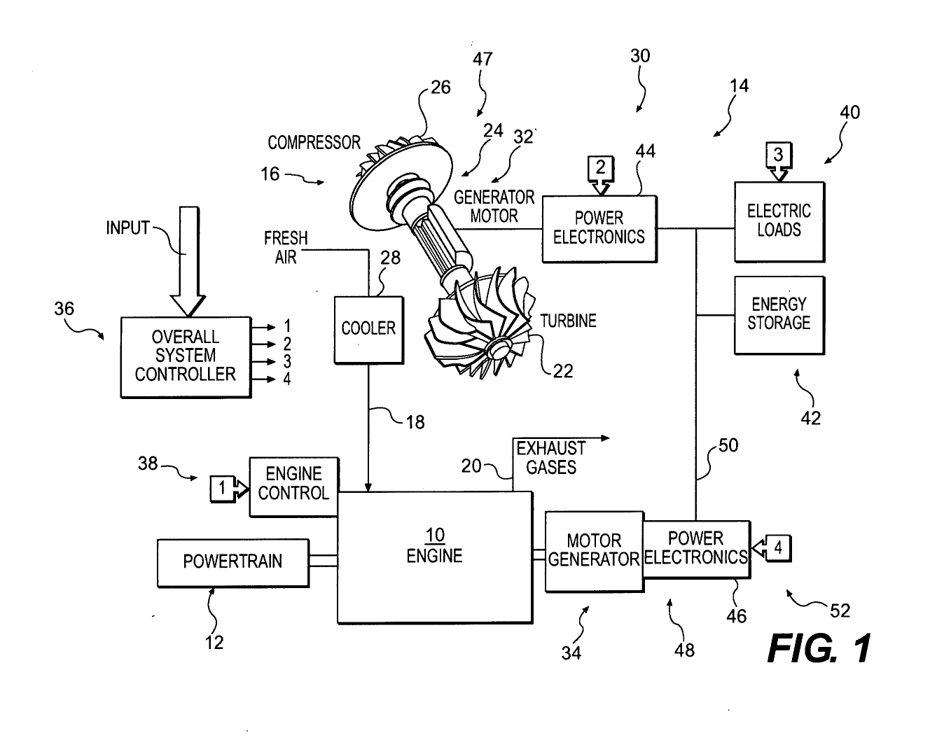

Referring to FIG. 1, an engine 10 is shown associated with a load or power train 12 which the engine 10 drives during its operation. Commonly, a power train 12 may be a transmission, drive shaft, and wheels of a vehicle or machine (not shown). Alternatively (or additionally), the power train 12 may be in the form of a generator used to produce electrical energy, such as a stationary power generator. Engine 10 may be, for example, a four cycle (i.e., four-stroke) internal combustion engine, and may include multiple cylinders. Engine 10 may be a compression ignited engine, such as a diesel engine, and may be fueled by any fuel generally used in a compression ignited engine, such as diesel fuel. Alternatively, engine 10 may be of the spark ignited type and may be fueled by gasoline, natural gas, methane, propane, or any other fuel generally used in spark ignited engines.

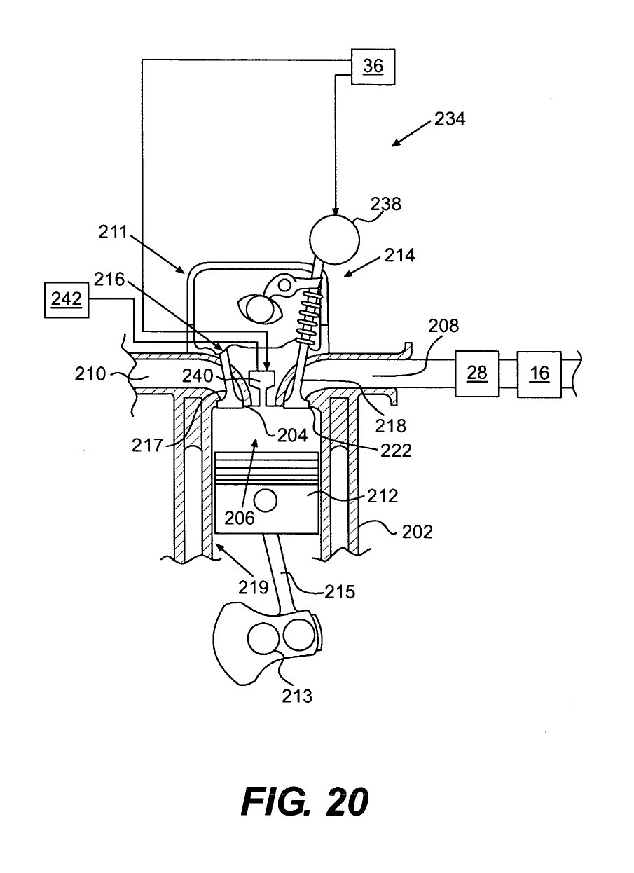

FIG. 20 diagrammatically illustrates certain operational details in connection with one cylinder of engine 10. The illustration in FIG. 20 and the following description may be representative of each of the cylinders of engine 10. Piston 212 may reciprocate within cylinder 219 mounted in engine block 202. Intake valve assembly 214 may be associated with cylinder head 211 and include an intake valve 218. A variable intake valve closing system 234 may include intake valve assembly 214 and a variable intake valve closing mechanism 238, controlled by system controller 36. Under control of the variable intake valve closing system 234, intake valve 218 may selectively open to admit air and/or an air/fuel mixture to cylinder 219 through intake port 222, and may selectively close to capture air and/or an air/fuel mixture within cylinder 219. In addition, intake valve 218 may selectively open to admit a mixture of air and engine exhaust gases, or a mixture of air, fuel, and engine exhaust gases, and may selectively close to capture the mixture of air and engine exhaust gases, or the mixture of air, fuel, and engine exhaust gases, within cylinder 219.

Intake air and/or air/fuel mixture may flow toward intake port 222 and cylinder 219 via intake flow path 208 after having been compressed by at least one pre-compression unit, such as turbocharger 16, and then cooled by one or more cooling units, such as cooler 28. Similarly, a mixture of air and engine exhaust gases, or a mixture of air, fuel, and engine exhaust gases, may flow toward intake port 222 and cylinder 219 via intake flow path 208 after having been compressed by at least one pre-compression unit, such as turbocharger 16, and then cooled by one or more cooling units, such as cooler 28. Thus, cooled, pressurized air, or a mixture of cooled, pressurized air and fuel, or a mixture of cooled, pressurized air and engine exhaust gases, or a mixture of cooled, pressurized air, fuel, and engine exhaust gases, may enter a combustion chamber 206 partially defined by piston 212. Once combustion has occurred within combustion chamber 206, exhaust valve 217 of exhaust valve assembly 216 may selectively open to permit the exhaust of gases from combustion chamber 206 through exhaust port 204 and into exhaust flow path 210, and may selectively close to inhibit the flow of gases through exhaust port 204. A suitable fuel may be admitted to combustion chamber 206. For example, in lieu of or in addition to any fuel that may be supplied to combustion chamber 206 along with intake air, fuel may be delivered directly to combustion chamber 206 via a fuel injector assembly 240 provided with fuel from a suitably fuel supply 242.

Summarizing, restating, and expanding on the description thus far, engine 10 may be a four-stroke, internal combustion engine including at least one combustion chamber 206 with at least one intake port 222 associated therewith. Piston 212 may partially define the chamber 206 and be movable in a reciprocating manner within a cylinder 219 through a plurality of power cycles. Each power cycle may involve four strokes of the piston 212 resulting from two rotations of a crankshaft 213 driving connecting rod 215. The four strokes may include an intake stroke, a compression stroke, an expansion stroke (also known as a combustion stroke or a working stroke), and an exhaust stroke. Each power cycle may be aided by combustion taking place within the chamber 206.

Air may be compressed and cooled outside the chamber 206, for example by turbocharger 16 and cooler 28. Cooled, pressurized air may be supplied to the at least one intake port 222 associated with the chamber 206. During each cycle of the plurality of power cycles, the at least one intake port 222 may be opened, thereby allowing cooled, pressurized air to flow through the at least one intake port 222 and into the chamber 206 during at least a portion of the intake stroke. The at least one intake port 222 may be maintained open during the portion of the intake stroke and beyond the end of the intake stroke and into the compression stroke and during a majority portion of the compression stroke.

The term “majority portion of the compression stroke” is a term associated with Miller Cycle engine operation. A particular characteristic of the Miller Cycle is that the intake valve closes either early during the intake stroke, or late during the compression stroke. The term “majority portion of the compression stroke” refers particularly to a variety of late intake valve closing Miller Cycle in which the intake valve closes after remaining open for more than 90 crank angle degrees of the total 180 crank angle degrees in the compression stroke. In other words, the intake valve closing after a “majority portion of the compression stroke” refers to the intake valve closing after piston 212 travels through more than half of the compression stroke.

To further explain the term “majority portion of the compression stroke,” it is important to note that the beginning of the compression stroke is when the piston 212 is at its bottom dead center (BDC) position, after the piston 212 has completed its entire intake stroke. Piston 212 travels through a “majority portion of the compression stroke” when the crankshaft 213 rotates more than 90° after bottom dead center (greater than 90° ABDC) of the compression stroke. When the at least one intake port 222 is maintained open into the compression stroke and during a “majority portion of the compression stroke,” intake valve 218 does not close intake port 222 until more than 90° ABDC.

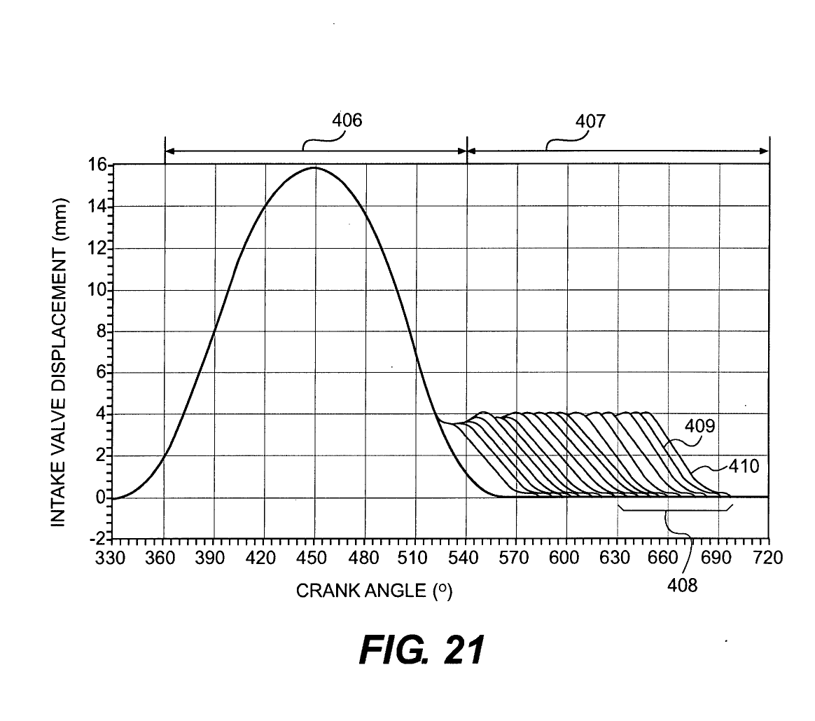

FIG. 21 graphically illustrates intake valve timing in accordance with exemplary disclosed embodiments. In connection with FIG. 21, it should be understood that 720 degrees represent two complete rotations of crankshaft 213 occurring during each four-stroke power cycle and that 0 degrees (not shown in FIG. 21) constitutes the beginning of the expansion stroke. Intake valve 218 (see FIG. 20) may begin to open at about 360° crank angle, that is, when the crankshaft 213 is at or near a top dead center (TDC) position of an intake stroke 406. The closing of the intake valve 218 may be selectively varied so as to close the intake port 222 at any crank angle position 407 in the compression stroke, ranging from BDC of the compression stroke (540° in FIG. 21) to TDC of the compression stroke (720° in FIG. 21). FIG. 21 graphically illustrates various intake valve closing positions at 408, representing the intake valve 218 remaining open for a majority portion of compression stroke 407. Each of the intake valve displacement profiles associated with the valve closing positions 408 show the intake valve 218 held open for a majority portion of the compression stroke 407, that is, for the first half of the compression stroke 407 (in FIG. 212, from 540° to 630°) and a portion of the second half of the compression stroke 407 (in FIG. 21, greater than 630°).

After the at least one intake port 222 is maintained open, the at least one intake port 222 may be closed at a point during travel of the piston 212 to capture in the chamber 206 a cooled compressed charge comprising the cooled, pressurized air (and any fuel and/or recirculated exhaust gas introduced into the chamber 206 along with the air). Fuel may be controllably delivered into the chamber 206 after the cooled compressed air is captured within the chamber 206, and the fuel and air mixture may be ignited within the chamber 206. While fuel may be delivered to chamber 206 directly via fuel injector unit 240, it will be understood that fuel may be mixed with the intake air at some point outside chamber 206, e.g., upstream of turbocharger 16 so as to form a fuel/air mixture that may be compressed within turbocharger 16 and subsequently cooled by cooler 28 before entering chamber 206.

The variable intake valve closing system 234 may close the intake valve 218 at a first crank angle during one four stroke cycle of the piston 212, and at a second crank angle during another four stroke cycle of the piston 212, with the first crank angle being different from the second crank angle. Both the first crank angle and the second crank angle may occur after a majority portion of the compression stroke has occurred. For example, referring to FIG. 21, the closing crank angle represented by alternative curves 409 and 410 both occur after a majority portion of the compression stroke. During a given plurality of four stroke cycles, intake valve 218 (FIG. 20) may close along curve 409 in one cycle, and close along curve 410 in a succeeding cycle. The variable intake valve closing system 234 may permit delaying or retarding the closing of intake valve 218 to any extent into the compression stroke. For example, in one exemplary embodiment, the intake valve 218, and thus intake port 222, may be maintained open for at least 65% of the compression stroke (which is about 117° ABDC of the compression stroke). In other exemplary embodiments, the intake valve 218 and intake port 222 may be maintained open for at least 80% or 85% of the compression stroke (which is about 144° or 153° ABDC of the compression stroke). Maintaining the intake port 222 open for a majority portion of the compression stroke may occur, for example, during high load operation of the engine 10.

Overall system controller 36 may be configured to control operation of the variable intake valve closing mechanism 238 and/or fuel injector assembly 240 based on one or more engine conditions, such as, engine speed, load, pressure, and/or temperature in order to achieve a desired engine performance. The controller 36 may be in the form of a single controlling unit or a plurality of units. Where the engine is a natural gas or gasoline engine, spark timing may be controlled by controller 36 in a fashion similar to fuel injector timing of a compression ignition engine.

Controllable delivery of fuel into the chamber 206 via fuel injector assembly 240 may include injecting a pilot injection of fuel and injecting a main injection of fuel. The pilot injection of fuel may commence when the crankshaft 213 is at about 675 crank angle degrees, that is, about 45° BTDC of the compression stroke. The main injection of fuel may occur when the crankshaft 213 is at about 710 crank angle degrees, that is, about 10° BTDC of the compression stroke and about 35° to 45° after commencement of the pilot injection. Generally, the pilot injection may commence when the crankshaft 213 is about 40° to 50° BTDC of the compression stroke and may last for about 10-15 degrees of crankshaft rotation. The main injection may commence when the crankshaft 213 is between about 10° BTDC of the compression stroke and about 12° ATDC of the expansion stroke. The main injection may last for about 20-45 crank angle degrees of rotation. The portion of fuel injected in the pilot injection may be about 10% of the total fuel injected in both the pilot and main injections.

Turning again to FIG. 1, control system 14 is associated with the engine 10. The control system 14 has the broad purpose of controlling operation of the engine 10 to achieve the purposes assigned to the engine 10 for particular applications. For example, in an on-highway vehicle, the control system 14 may be designed and/or programmed to assure that the engine operates within certain parameters optimum or otherwise appropriate to highway cruising. In generator or off highway applications, the control system 14 may be designed and/or programmed to assure that different parameters are used for efficient operation. In the example shown, the control system 14 will not be discussed specifically for one application or another. Rather, its operation with respect to engine operating conditions and desirable performance characteristics of engines will be discussed. It is within the capabilities of those skilled in the art to apply the principles to specific applications.

In addition to turbocharger 16, the engine 10 (FIG. 1) has an intake manifold 18 and an exhaust manifold 20. As is well known, exhaust gas from the engine 10 will pass through the exhaust manifold 20 and across a turbine 22 of the turbocharger 16 in exiting the engine 10. The turbine 22 is driven by the exhaust gases and turns a shaft 24 on which a compressor 26 is mounted. The compressor 26 is driven by the shaft 24 and compresses intake air delivered to the engine 10 through intake manifold 18. In this embodiment, the intake air is shown further passing through a cooler 28 which includes a heat exchanger to make the incoming air more dense. The turbine may have fixed or variable vanes, the latter providing an additional degree of flexibility in the system.

The engine 10 further has a turbocompounding or TC system 30. The turbocompounding system 30 includes a first electric device 32 (also referred to herein as a first electric machine) associated with the turbocharger 16 and a second electric device 34 (also referred to herein as a second electric machine) associated with the crankshaft of engine 10. Both electric machines 32, 34 are preferably capable of operating in a mode to generate electrical power (that is, as a generator or an alternator) or in a mode to consume electrical power and convert it to rotational (mechanical) power (that is, as a motor). For convenience, in describing the first electric device 32 when operating as a generator, or alternately as a motor, those terms accompanied by reference numeral 32 will be used. The same will be the case for the second electric machine 34. Such electric devices 32, 34 are also sometimes referred to as motor/generators to indicate their dual functions.

The first electric machine 32 may be incorporated with the turbocharger shaft 24. This is accomplished by having the rotor (not shown) as part of the shaft 24, with the stator (not shown) in a fixed position about the shaft 24. The second electric machine 34 may be connected through its rotor (not shown) to the crankshaft (not shown) of the engine 10. The construction and connection of such electric machines are well known and will not be described in detail.

In the context of the control system 14 and its TC system 30, there are several elements that will be now disclosed in overview and then in detail later. Included is an overall system controller 36 that provides comprehensive management and interfaces with an engine control 38 and electrical loads 40 and energy storage capabilities 42. The system 14 further interfaces with power converters or controllers 44, 46 associated with the first and second electric machines 32, 34, respectively. As will be explained, the first electric machine controller 44 is capable of regulating the electrical power generated by the first electric machine 32. The second electric machine controller 46 is capable of setting or regulating a desirable electrical demand of the second electric machine 34. Thus, it can be considered that the first electric machine 32 and controller 46 constitute an electrical power supply sub-system 47, while the second electric machine 34 and controller 44 constitutes a second electrical demand sub-system 48. The sub-systems 47, 48, the electrical loads 40, and energy storage 42 are connected by an electrical bus or circuit 50. The control system 14, engine 10, electrical loads 40, energy storage 42, and load or power train 12 may represent, for example, a larger system 52 that is part of a vehicle or generator set as previously mentioned.

The primary mode of operation for the TC system 30 is when the first electric machine 32 is operating as a generator. The first power converter 44 regulates the electrical power produced by the generator 32. The second electric machine 34, operating as a motor, draws power, and assists the engine 10 by putting mechanical power into the crankshaft. Excess electrical power can be put into the electrical storage 42 or used to power the electrical loads 40. However, if generator 32 were unable to provide sufficient electrical energy for a particular situation, motor 34 could draw from the electrical storage 42. While the electrical storage capability 42 adds flexibility in this sense, it is not required for TC system 30.

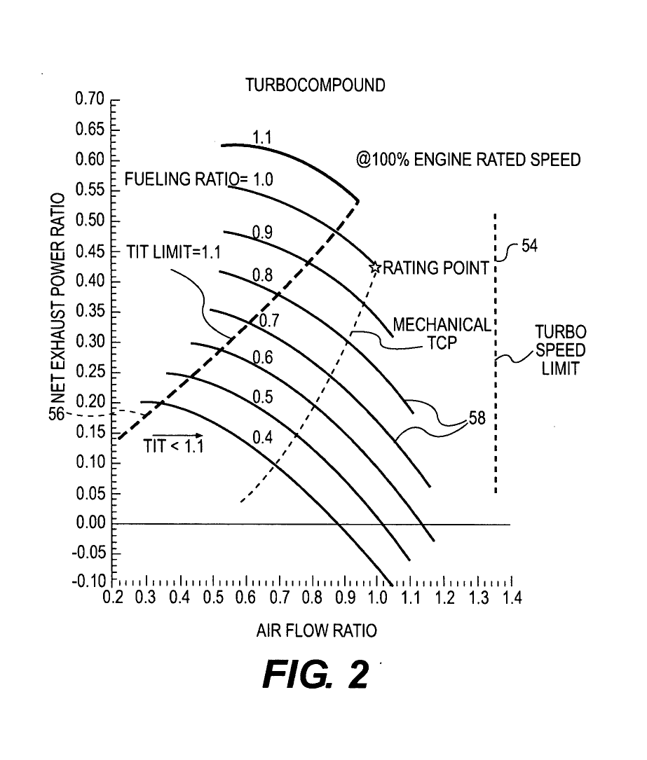

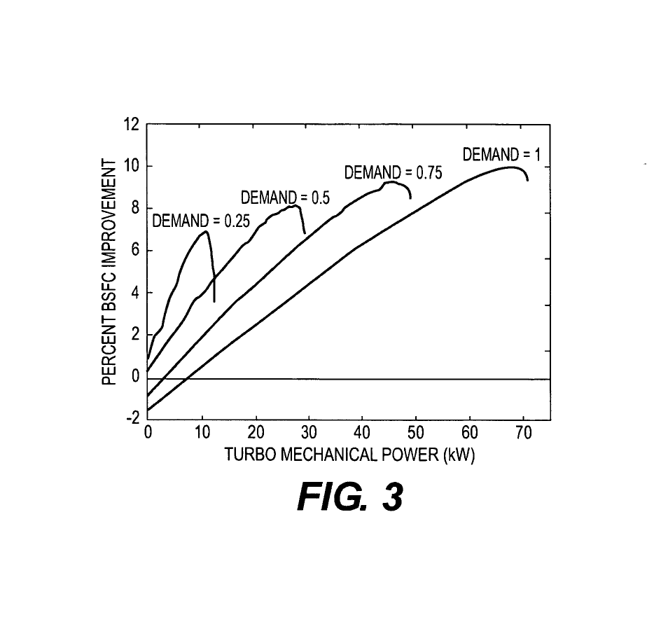

The overriding purpose is to achieve system efficiency. FIG. 2, as well as subsequent FIGS. 3-17, will be used to illustrate basic principles of engine or system response and how system efficiency can be controlled. The data in these figures is derived from computer simulation. It should be understood that similar results to illustrate the principles discussed may be derived from actual engine tests or other computer simulations. Thus, one can use the illustrated principles to understand how to apply the described systems, steps, methods or processes for a particular application.

Apart from the balance of electrical energy produced and consumed being important, the engine 10 should operate at a desired peak efficiency. This peak efficiency will typically be determined as peak efficiency or operating points for given engine speeds and loads. One of the limits to the ability to operate at such peak points is turbocharger capability. As illustrated in FIG. 2, the operating envelope can be wide in a relative sense for system capability, even though such considerations as mechanical, thermal, and emissions constraints have effect.

Specifically, FIG. 2 illustrates turbocharger operation for certain conditions. The vertical dashed line 54 on the right represents the maximum allowable speed for the turbocharger 16. The diagonal running dashed line 56 on the left represents the maximum allowable turbine inlet temperature (in this case, nine hundred and twenty (920) degrees Kelvin). The parallel arched lines 58 represent lines of constant fueling rate (normalized with respect to the nominal fuel rate at the rated power point (that is, 100%)). Other conditions (all at one hundred (100) percent of engine rated speed) are a pressure ratio of the compressor in atmospheres, or PR_{comp}, of 3.0 at an overall turbine efficiency of eighty (80) percent efficiency and a BP/Boost ratio of 1.24. “PR_{comp}” is defined as the ratio between the pressure at the outlet of the compressor over the pressure at the inlet of the compressor. “BP” is the exhaust gas pressure before the turbine. “Boost” is the charge air pressure at the compressor exit.

It will be seen from FIG. 2 that, by controlling the amount of electrical power generated for a given fueling condition, the TC system 30 can be made to run between the lines 54, 56 representing the maximum allowable turbocharger speed and the maximum turbocharger inlet temperature. While specific parameters are shown on the graph of FIG. 2, such parameters are not as important as what the graph illustrates. It will be appreciated that FIG. 2 basically illustrates an operating envelope for the turbocharger 16 (between lines 54 and 56) where the turbocharger can be flexibly used. Thus, pre-set parameters can be used to protect the turbocharger 16. Given this flexibility, the control system 14, and in particular the TC system 30, can be designed and/or programmed for control strategies to achieve desirable efficiencies for given situations. For example, the control strategy may be presented to provide for maximum air handling efficiency, maximum turbocharger response, lower emissions (such as NOx), or maximum fuel economy.

To illustrate, the approach of maximizing fuel economy is illustrated in FIG. 3. FIG. 3 illustrates the improvement in brake specific fuel consumption (BSFC) for an engine simulation that may be achieved by recovering energy from the engine exhaust gases. Again, the specific (assumed) parameters of the engine simulation are not as important as the instruction they provide. For a given engine or control system, similar results can be achieved and applied. For this illustration, it is assumed that the entire generator output is used to drive the motor 34 and, thus, engine 10. The motor efficiency is assumed to be ninety-two percent (92%) for motor 34 and engine speed is one thousand five hundred (1500) RPM. The four curves in the graph represent different engine loading conditions or demand. From left to right, the curves represent twenty-five percent (25%), fifty percent (50%), seventy-five percent (75%) and one hundred percent (100%) of the maximum available torque at the engine speed.

From FIG. 3, it is seen that brake specific fuel consumption, or BSFC, as a percentage, improves as more exhaust gas energy from the engine is recovered (represented along the x-axis) and used by the generator 32 to produce electrical power that drives the motor 34. For each load condition (for example, twenty-five percent (25%) of rated load), there is a point beyond which BSFC deteriorates from additional recovery of energy from exhaust gases. This illustrates that to maximize fuel economy, the engine 10 should be kept at the optimum operating point for each engine loading condition. In a similar fashion, the importance of optimum operating points for additional beneficial effects, such as lower emissions and others mentioned above, can be shown.

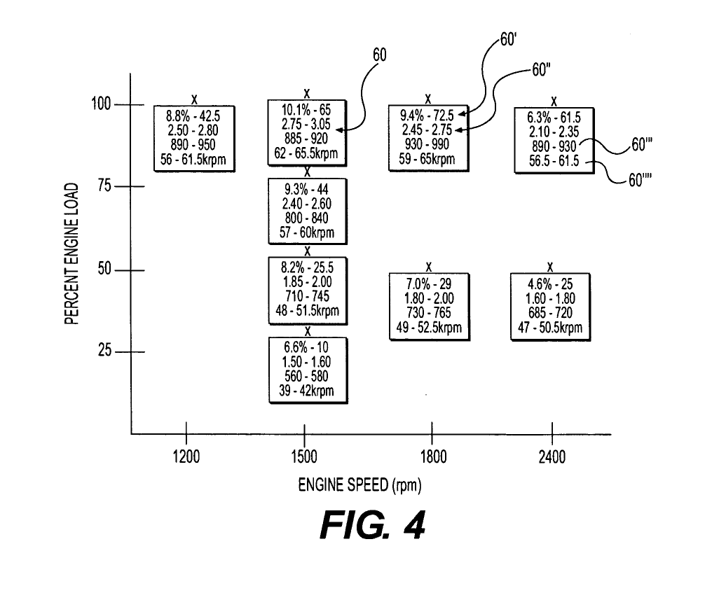

Exploring further the goal of maximizing fuel economy through the TC system 30, FIG. 4 illustrates values for certain variables 60 at each optimum operating point of maximum fuel economy for different engine loading conditions. These values were obtained by a computer simulation for an engine (as in FIG. 3) at the load conditions of twenty-five percent (25%), fifty percent (50%), seventy-five percent (75%) and one hundred percent (100%) of the maximum available torque at a given engine speed. Variables 60 are shown for nine different operating points and include exhaust gas power recovered 60′, intake manifold pressure 60″, engine exhaust temperature 60″′, and turbocharger speed 60″″. An associated percentage improvement of BSFC is also shown for each operating point. As will be noted, FIG. 4 has the data from FIG. 3 for the variable represented by the recovery of engine exhaust gas power.

FIG. 4 further illustrates, through computer simulation, that the variables shown are not independent of one another in a steady state condition. In fact, for a given engine steady state operating condition, there is a unique set of values for all of these variables. Thus, if one of the variables is controlled, the others would result. The result is that strategies to maintain desired operating conditions for the engine 10 can be based upon controlling any of the variables. However, transient behavior associated with each strategy will vary. This will be illustrated in discussing FIGS. 5-13, each of which illustrates results obtained based upon the control of a different variable.

Referring to FIGS. 5-7, the engine exhaust temperature will be used as the controlled variable. In this case, the objective will be to maintain the engine exhaust temperature at a fixed value or constant set point of 760 degrees K (illustrated in FIG. 6). The engine speed, for simplicity, is kept at a constant rate of 1800 RPM (assumes very large inertia). In FIG. 5, a command for a ten percent (10%) step change in engine demand (y-axis) occurs at five seconds (x-axis). This command will be converted by the engine control 38 as a request to increase engine torque. To respond to the requested increase in engine output, additional fuel will be injected into the engine 10. The additional injection of fuel leads to a quick rise in exhaust gas temperature (FIG. 6, y-axis). To bring the exhaust gas temperature down to the set point of 760 degrees K, more air will need to be pumped into the engine 10, which requires an increase in the speed of the turbocharger 16.

To increase the speed of the turbocharger 16, the generator 32 will need to have less braking effect on the turbocharger 16 that is caused when it produces electrical power. Thus, the generator 32 will need to produce less electrical power, thereby reducing the braking torque on the turbocharger 16 and allowing the turbocharger 16 to speed up. In extreme conditions, it should be noted that electric machine 32 may need to act as a motor to help increase the speed of the turbocharger 16 (discussed later).

With less electrical power available from generator 32, the amount of torque assisting the engine 10 through the motor 34 will decrease. This is evident from the sudden drop of crankshaft torque measured along the y-axis in FIG. 7. As soon as the exhaust gas temperature begins to decrease through increased air flow into the engine 10 (FIG. 6), additional power can be recovered from the engine exhaust gases. Thus, it will be noted that crankshaft torque (FIG. 7) will increase. In addition, the engine will be working at a higher crankshaft torque level because of the increase in fueling occurring with the command for higher engine load (increased demand).

The strategy discussed in relation to FIGS. 5-7 has an undesirable characteristic for such things as the drivability of a vehicle in which the engine 10 may be used. This can be seen from FIG. 7 where the initial response of the system 14 is a decrease in crankshaft torque when higher demand is placed on the engine 10 (FIG. 5).

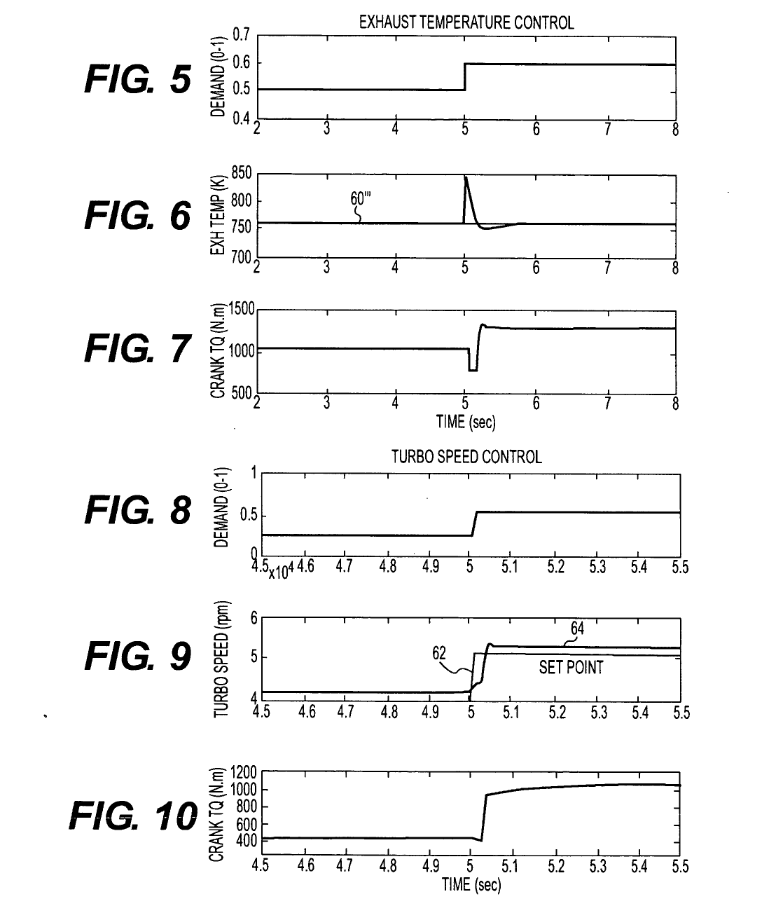

A second approach will now be illustrated that uses turbocharger speed as the controlled variable. FIG. 8 shows the response to a step change in engine load from twenty-five percent (25%) to fifty (50%). Again, a constant engine speed of 1800 RPM is used. The desired increase in turbocharger speed is shown by a set point trace 62 in FIG. 9. The trace 62 shows that the turbocharger speed would desirably increase from 41,500 RPM to 51,000 RPM to reach a new equilibrium point. As is shown by the simulation result (represented by line 64 in FIG. 9), actual turbocharger speed does increase closely to the desired trace. Thus, the fueling increase accompanying an increase in engine demand (FIG. 8), leads to higher energy in the exhaust gases of the engine 10 and the higher turbocharger speed. It can also be seen in FIG. 10 that an increase in crankshaft torque likewise occurs. Thus, the direction of the control action, or increase in engine demand, is consistent with the natural response of the system 14. Using this control approach, therefore, minimizes the impact on crankshaft torque, because the actual torque response of FIG. 10 is directionally correct with respect to the change in the commanded torque at all times.

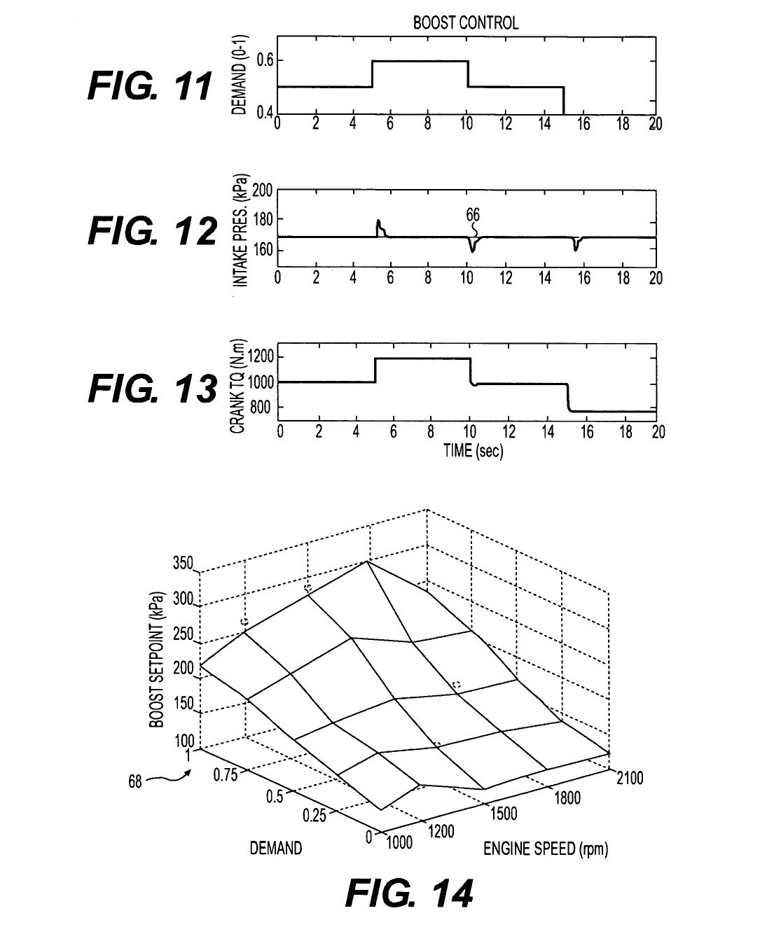

FIGS. 11-13 will be used to illustrate engine intake pressure (boost) as the variable being controlled. In FIG. 11, a series of step responses is shown that corresponds to ten percent (10%) changes in engine load. The objective is to maintain engine boost at approximately 170 kPa (shown as Setpoint line 66 in FIG. 12). Upon encountering the first step change in engine load from fifty percent (50%) to sixty percent (60%) at about five (5) seconds, the intake pressure shown in FIG. 12 rises suddenly. The intake pressure, though, is quickly restored to its desired level by TC system 14 causing the generator 32 to produce more power. This is because additional load on generator 32 that causes it to produce more electrical power will slow turbocharger 16. Slowing turbocharger 16 will reduce the amount of intake air going into the engine 10, which lowers engine boost. The increased electrical power being produced by the generator 32, however, is available to assist the engine 10. Because of this, additional torque (FIG. 13) is introduced into the crankshaft through motor 34, aiding total torque production of the engine 10. It can be further seen at about 10 seconds (FIG. 12) that, when engine load steps down, engine boost will decrease along with the amount of additional torque introduced into the crankshaft through motor 34 (FIG. 13). A similar situation occurs at about 15 seconds on the X-axis.

FIGS. 11-13 illustrate that controlling boost pressure is very desirable. This is because when engine demand changes, engine boost and additional torque to the engine 10 from motor 34 change in a directionally consistent way. Furthermore, engine boost is maintainable in a fairly consistent fashion when compared to the set point. This is favorable in operation of the engine 10 in a vehicle or other application.

The prior three examples illustrate the control of different variables (i.e., control variables) to regulate the control system 14 and TC system 30. The control of engine boost is considered particularly effective for the reasons stated in the prior paragraph. However, to maximize BSFC, for example, engine boost (as would other variables) must be adjusted as a function of engine speed and load or other operating conditions during the engine's operating cycles.

In order to adjust engine boost or another variable as a function of engine speed and load, control system 14 or TC system 30 needs access to the desired or optimum operating values (set points) for the control variable for a system set up to maximize BSFC. This is commonly done through a Setpoint Map 68, such as shown in FIG. 14. In FIG. 14, the boost values from FIG. 4 have been plotted against engine speed and load. This map can, as will be explained later, then be used as a look up table for TC system 30.

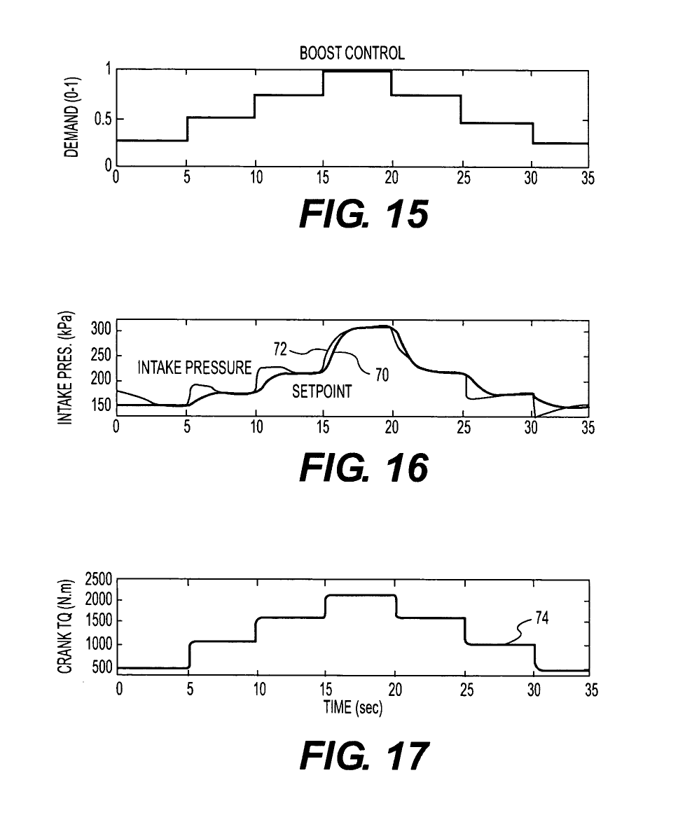

To illustrate the use of the Setpoint Map 68, FIGS. 15-17 are presented to show the time response to step changes in engine load with engine speed kept at a constant 1800 RPM. Each change in engine load in FIG. 15 is accompanied by a corresponding change in the engine boost set point shown by trace 70 in FIG. 16. The actual simulation results are shown by bold line 72. Further, compensation (discussed later) is introduced in this example to soften the response to boost pressure by slowing changes in the boost. In other words, signal compensation (in this case, a first order lag filter) has been used to match the time constant of the set point filter to the boost time constant. It is shown in FIG. 16 that boost response represented by bold line 72 can be made to match step changes in engine demand (FIG. 15) very closely. Compared to FIG. 12, it will be seen that this compensation helps to avoid overshoot conditions for better engine response.

It will be appreciated that, from a propulsion and drivability standpoint, the variable of most interest is the overall torque (power) produced by the combination of engine 10 and motor 34. The trace 74 in FIG. 17 shows the sum of the torque produced by the crankshaft of the engine 10 and motor 34. The torque closely follows the requested changes in engine demand illustrated in FIG. 15. This further illustrates that the TC system 30 has the capability to provide very good drivability characteristics.

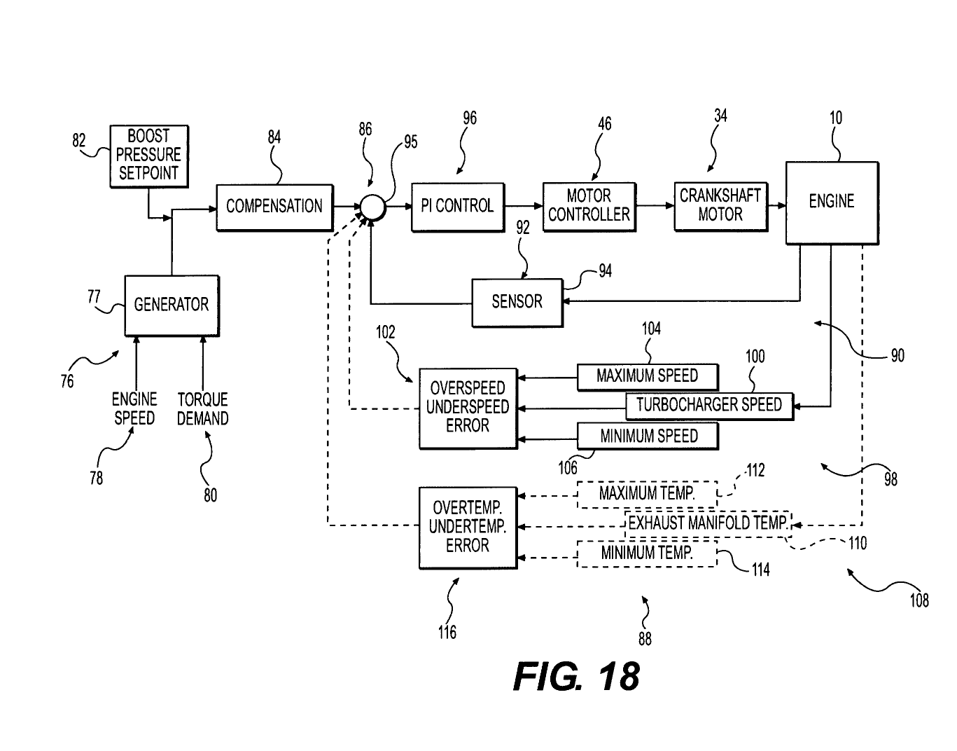

Additional detail for the overall control system 14, and specifically the TC system 30, is shown in FIG. 18. The illustration shows the control system 14 configured to utilize boost control to regulate operation of the TC system 30. In other words, the control variable selected is boost. This is an approach previously described in the examples illustrated by FIGS. 15-17. It will be noted that the engine 10 is controlled by the engine control 38 (sometimes called an ECM or engine control module) shown in FIG. 1.

Referring to FIG. 18, at step 76, a Set Point Generator 77 receives inputs of engine speed 78 and torque demand or load 80 on the engine 10 from sensors or other ways well known. The Set Point Generator 77 is a control device that functions to provide a signal at step 82 representative of desired or optimum manifold pressure or boost for the engine conditions 78, 80 observed. Thus, it performs a step of identifying optimum operating values for the boost control variable at operating conditions for the engine 10. In this example, Set Point Generator 77 uses the map such as shown in FIG. 14, but other approaches are known and may be used. The Set Point Generator 77 will “look up” the desired boost set point from the map, and send a signal to compensator 84. Compensator 84 implements a first order lag compensation to adjust the boost and avoid overshoots in boost pressure as previously illustrated with respect to FIGS. 15-17. Thus, at juncture 86 a filtered or compensated boost set point is provided that is desired or optimum for the engine speed and load conditions. The compensator in this example is embodied in software of the control system 14.

Also in FIG. 18 is a control sub-system 88 with further control features for control system 14. In this example, the sub-system 88 illustrates the use of three control variables: boost, engine exhaust temperature, and turbocharger speed. The primary control aspect of the sub-system 88, as mentioned, is the use of a first or boost pressure feedback loop 90. This control or loop 90 is the primary control for regulating boost pressure in conjunction with the filtered boost set point delivered at 86. The actual intake manifold pressure is sensed at box 92 by a suitable sensor 94. A signal representing actual boost pressure of the engine 10 at a given point in time is then delivered to juncture 86 where it will be used for control purposes as explained below.

In the next step, a comparator 95 receives the boost pressure signal that is measured (simulated in the example) for engine operating conditions and the comparable, desired boost set point at juncture 86. Comparator 95 is represented in this example simply by operation of a “subtraction” statement in software. The comparator 95 compares the two signals and identifies a difference in the two signals. From this comparison, an “error” signal is produced. A step is then performed in which a demand control 96, in response to the error signal, provides a command signal to motor control 46 (described in more detail below) to control the torque output of motor 34. This results from regulating the amount of current going into the motor as to be explained later. Demand control 96 in this example is a proportional, integral control 96. This step thus controls the demand for electrical power of the second electric machine or motor 34 in response to the difference in the control variable from the measured or simulated control variable at certain engine operating conditions.

Two additional, exemplary feedback loops are illustrated in FIG. 18 based upon the two different control variables mentioned above. The second feedback loop 98 acts as an over-speed or under-speed control mechanism by maintaining rotational speed of the turbocharger 16 within a specified range. Actual turbocharger speed is measured at step 100 and compared at step 102 by the comparator 95 to set points 104, 106 of maximum speed and minimum speed. If the turbocharger 16 is above or below a set range, an adjustment can be made through the PI Control 96 to control motor 34 and bring the turbocharger back within the range. The allowable speed range for turbocharger 16 may also be varied based upon engine operating conditions. The range may also be made very narrow so that turbocharger speed would essentially follow a set speed (speed set point).

The third feedback loop 108 is an exhaust manifold temperature loop to keep exhaust temperatures within specified limits. It acts in a manner similar to the second loop 98 by measuring actual exhaust manifold temperature at 110 and using comparator 95 to compare that temperature to set points 112, 114 for maximum and minimum manifold temperatures, respectively. The comparison is made at step 116 and an error signal is subsequently delivered through juncture 86 to contribute to the control of motor 34. Set points 112, 114 can alternately be made variable to adjust to engine operating conditions or can be made very narrow to “force” engine 10 to operate at a desired exhaust manifold temperature.

While not illustrated, the second and third feedback loops 98, 108 may further have feedback compensators after the comparisons at 102, 116 are made, respectively. Again, it is contemplated that these compensators will be embodied in the software of control system 14. Further, comparator 95 may represent or have a separate comparator for each control variable used depending upon the choice made in the system.

Yet another example of a feedback loop may be to manage emissions. A loop that measures engine NOₓ, and compares it to set points, may be used to maintain the engine 10 within desired emission control specifications. Other loops may be added or substituted from those described above depending upon the control mechanisms desired for certain engines or applications. Of course, the control limits or set points used may also be adjusted to achieve a variety of desired operating characteristics. It will be appreciated that loops used in addition to the primary loop (such as first feedback loop 90) also provide redundancy to the control system 14 and TC system 30. Thus, for example, if the boost sensor of loop 90 fails, engine 10 will not exceed certain parameters to protect against mechanical failure or exceeding mandated parameters.

From the above, it will be seen that the control sub-system 88, using feedback loops in the illustrated examples, provides a function to control the amount of power being recovered in the TC system 30. It provides operating conditions of the engine 10 from the feedback loops 90, 98, or 108. Desired operating points of the engine 10, as delivered at juncture 86, are compared to fulfill the control function.

In the example represented by FIG. 18, the various systems, loops and steps were directed to regulating demand of the second electrical machine or motor 34. A signal, based upon the inputs of boost pressure set point and the feedback loops 90, 98, 108, was the output of PI control 96 to set the demand for the motor 34. This motor demand is present on the electrical bus 50, as will be the demands of the electrical loads 40 and energy storage 42 where present. Such demand can be identified as either current or voltage and used to control the supply of electrical power by the generator 32. Controlling the electrical power consumed by motor 34 directly controls the load on the first electrical machine or generator 32. Thus, the load on the turbocharger 16 is directly controlled. It will be appreciated that the less electrical power (current) that is consumed by the motor 34, the less current the generator 32 will need to produce to maintain the voltage of the bus 50 constant. Further, turbocharger 16 will also provide higher boost due to less drag from the generator 32 in producing less electrical power to supply the demands of motor 34.

In summary, therefore, a step provides for the control, such as with PI Control 96, to adjust the operating condition of the engine 10 through changing demand of the motor 34 on the generator 32. This process will tend, through engine operating response to these changes, to make the actual operating condition of the engine more closely approximate the desired operating condition. Thus, the signals representative of the desired or optimum signal and the measured signal will tend to converge within capabilities to control the engine. Overall, the electrical power on the electrical bus 50 is regulated to meet the demand of the bus for one of measured current and voltage.

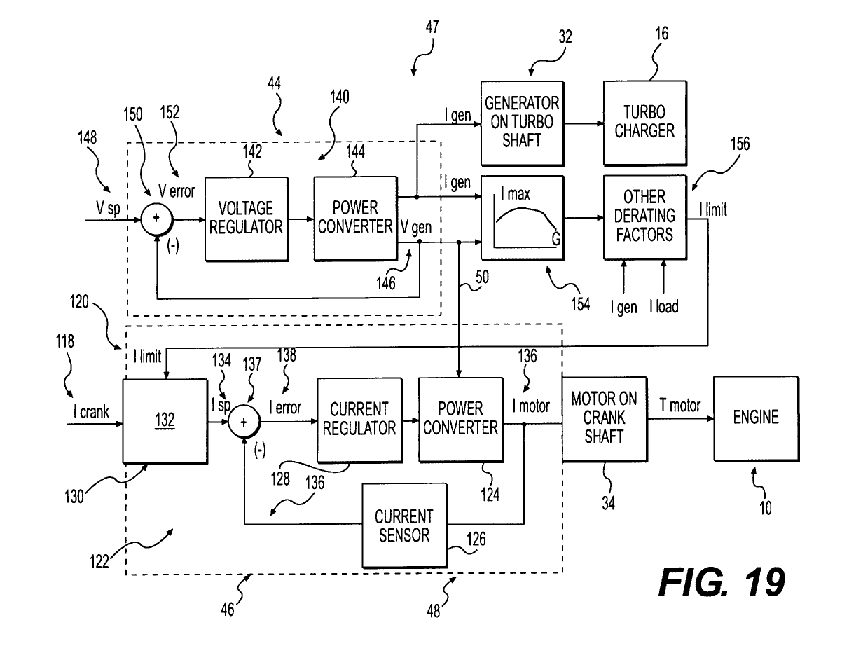

Referring to FIG. 19, the signal from PI control 96 is shown as I_{crank} 118 (denominating “crankshaft” motor 34). This “demand” signal from PI control 96 is delivered to the demand sub-system 46 that acts as a motor or demand control (also called out as 46) to set the demand for motor 34. The demand sub-system 46 regulates one of voltage and current in the bus 50 to achieve its purposes. Typically, it will regulate in terms of motor current, and thus current on the bus 50. Also shown in FIG. 19 is supply sub-system 44 that acts as a generator or supply control 44. The supply sub-system 44 regulates the other of voltage and current in the bus 50 to achieve its purposes. Typically it will regulate voltage.

Motor control 46 and generator control 44 (also shown in FIG. 1) are connected with one another through a portion of electrical bus 50 and exchange a signal Iₗᵢₘᵢₜ 120. Signal Iₗᵢₘᵢₜ 120 provides a mechanism to limit motor current demand to account for derating factors and/or limiting conditions that may be encountered during operation of control system 14. In other words, for example, if the windings of generator 32 get too hot and exceed normal operating conditions, the Iₗᵢₘᵢₜ signal will be used, as described below, to protect generator 32.

The motor control 46 utilizes a current loop 122 having a power converter 124, a current sensor 126, and a current regulator 128. This loop 122 within motor control 46 is used to maintain the motor 34 operating at the desired torque or load level. To illustrate, the signal I_{crank} 118 will ordinarily be used to control motor 34. However, as discussed above, the smaller of signal Iₗᵢₘᵢₜ 120 and signal I_{crank} 118 is selected at a step 130 to protect generator 32. Step 130 is simply represented by operation of an “if” statement or comparator 132 in software in the embodiment shown.

The selected signal or Iₛₚ 134 is used to develop an error signal or current differential. This is done by comparing Iₛₚ 134 to the actual current signal (Iₘₒₜₒᵣ 136) of motor 34 at step 137. A signal representing Iₘₒₜₒᵣ 136 current is generated by sensor 126 and delivered for such comparison purposes. The difference, or error signal 138 (Iₑᵣᵣₒᵣ), is used by current regulator 128 to set the demand for motor current. Current regulator 128 is also a proportional, integral control. The command for regulated current based upon the error signal 138 is subsequently delivered to a power converter 124 to provide adjustment to the current sent to the crankshaft motor 34.

The generator control 44 regulates the operation of generator 32. Thus, generator control 44 typically addresses the supply side of electrical power for the motor 34, while motor control 46 addresses the demand side. Control 44 is thus capable of regulating the electrical power generated by the generator 32. In the example shown, a voltage loop 140 controls the amount of electrical power produced by generator 32 to meet the electrical loads on electrical bus 50. In other words, generator 32 is controlled to maintain voltage in bus 50 at a desired value. The object is to tightly regulate the bus voltage, so that generator 32 produces the right amount of electrical power to supply motor 34 and any other loads present on bus 50.

Closed voltage loop 140 includes a voltage regulator 142 and combined generator and power converter 144 that includes generator 32. Actual voltage or V_{gen} 146 of generator 32 is compared with voltage demand or Vₛₚ 148 at step 150. The resultant error signal or Vₑᵣᵣₒᵣ 152 flows to voltage regulator 142 where it is conditioned for generator and power converter 144. Eventually, Vₑᵣᵣₒᵣ or will reduce to zero at steady state conditions for demand on bus 50, and, generator 32 will produce the electrical power necessary to meet such demand. Electrical circuit or bus 50 is thereby maintained at the desired voltage.

Outside of voltage loop 140 in FIG. 19 are additional control mechanisms to regulate output of generator 32 and motor 34. The engine 10, as previously discussed, will have ratings, limiting conditions, or other characteristics that it is desirable to control beyond the demand of motor 34 or other loads on bus 50. As an example, a set point map 154 and derating control 156 are used to determine the limit (Iₗᵢₘᵢₜ) of motor current that may be permitted. Thus, if a manufacturer desires to limit the torque that motor 34 can contribute to engine 10 for a given set point found on map 154, or based upon derating factors embodied in control 156, this functionality can be performed. As previously mentioned, Iₗᵢₘᵢₜ is used in motor control 46. Limiting the current to motor 34 constrains the electrical power demand on the generator 32, and thus the amount of mechanical power extracted from the turbocharger shaft. The more electrical power produced, the higher the braking torque on the turbocharger shaft. Thus, adjusting the electrical power produced by the generator 32 results in speeding or slowing of turbocharger 16. This affects the boost that turbocharger 16 provides to engine 10.

As earlier mentioned, electric machines 32, 34 may also operate alternatively as a motor 32 and generator 34, respectively. Such a situation will be desirable where, for example, the engine 10 is operating outside the envelope where exhaust energy recovery is feasible or otherwise being outside of certain operating parameters. One example of being outside acceptable parameters is where turbocharger lag is occurring. Lag is a condition where rotational speed of the turbocharger's compressor section is insufficient to meet air intake needs for a given demand on the engine 10. This will occur where the turbine section is unable to extract sufficient energy from engine exhaust gases. Turbocharger lag may occur when a vehicle is coasting and an operator pushes on the accelerator pedal of the vehicle to speed up. With the engine at exhaust gas energy levels from coasting, the turbocharger will be rotating slowly and not be able to react quickly enough to provide sufficient combustion air to the engine to meet requested demand.

The present system 14 will permit a switch over of the electrical devices 32, 34 to motor and generator functions, respectively. Switch over will occur in response to a signal from at least one or more sensors capable of providing a signal indicative of the out of parameter condition. Signals may also be input for other parameters for control purposes, as well. In the example above, change in demand results in a request for additional fuel to the engine that can be used as a signal to trigger the switchover to motor and generator functions while under an out of parameter condition. Fueling sensors (not shown, but typically used in the engine control 38 for other purposes) may be used to sense that demand. The signal produced by the sensor may be then input as torque demand 80 (FIG. 18). At the same time, the speed of the engine 10 is being sensed and input as engine speed 78.

Set Point Generator 77 (FIG. 18) uses signals 78, 80 to produce a new boost set point for the out of parameter condition. With electrical device 34 now acting as a generator, if the actual boost is below the desired value, control sub-system 88 increases the amount of electricity being produced. This results in additional current flow out of electrical device 34. To keep bus voltage 50 at the desired value, the current into electrical device 32 (acting as a motor) is increased. The increase results in additional torque being put onto the turbocharger shaft, which increases the speed of turbocharger 16 thereby providing more air to engine 10.

Step 76 in this example is capable of determining desired operating points for given operating conditions of the engine 10, including the out of parameter conditions. In an embodiment to be described, generator 77 will have first and second maps similar to the map shown in FIG. 14. The first map is used to determine desired operating points for engine conditions other than those associated with the out of parameter conditions. In other words, the first map will be used when controlling demand of the motor 34 and supply of the generator 32 (as discussed in earlier examples). The second map will be used to determine desired operating points for engine conditions associated with the out of parameter conditions. Likewise, controller gains and signal compensators within control sub-system 88 may take different values depending upon whether engine 10 is operating in “in” or “out” of parameter conditions.

By way of further explanation, the relative condition indicative of turbocharger lag (based from pre-determined high demand, low speed conditions) will cause the logic of Setpoint Generator 77 to choose the second Setpoint Map provided for such conditions. In response to the indicated conditions for turbocharger lag, second electric machine 34 will switch over to function as a generator and be capable of providing electrical power (from being driven by the crankshaft) to the first electric machine 32. The Setpoint Map for turbocharger lag conditions will be similar to that illustrated in FIG. 14, but will have turbocharger rotational speed values plotted against engine speed and load. In this map, engine speed will be representative of the requested demand. From this “lag” map, a set point is identified that will represent turbocharger rotational speed desirable or optimum for requested engine conditions.

Feedback loop 98 (FIG. 18) provides measured turbocharger speed so that an error signal at juncture 86 can be obtained from a comparison of the requested turbocharger speed and actual turbocharger speed. A comparator as at 95 compares the desired turbocharger speed from the second map and the operating speed of the turbocharger 16. A signal indicative of the comparison (i.e., an “error” signal) delivered to a control regulates the second electric machine 34. For illustrative purposes, the control will also be motor controller 46 from FIG. 18. This control 46 will have the further capability to regulate the second electric machine 34 to act as a generator 34. In response to the comparison and use of the error signal, generator 34 will provide a desired or demanded amount of electrical power to the first electric machine 32. The first electric machine 32 now acts as a motor in response to electrical energy being applied, and will act to increase the rotational speed of turbocharger toward the set point requested. This speed increase will provide more air to the engine 10 to satisfy demand. When the engine 10 is again operating without turbo lag, the first and second electrical machines 32, 34 will transition back to their generator and motor functions, respectively.

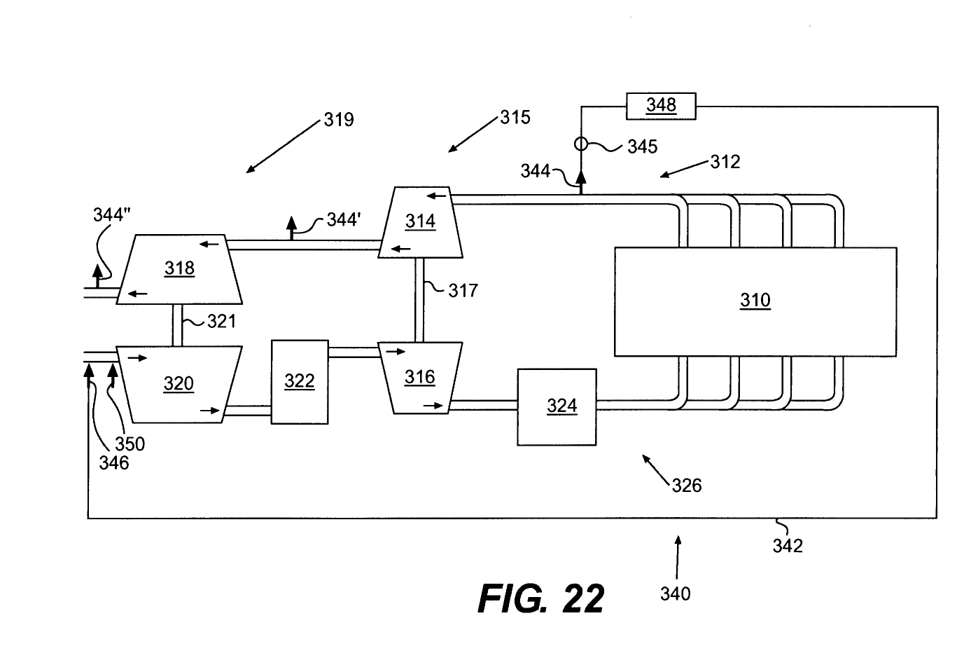

FIG. 22 illustrates an exemplary embodiment of an engine 310 (similar to engine 10 of FIG. 1 and having one or more engine cylinders and other components as shown in FIG. 20) which may employ a turbocompounding system with multiple stages of pressurization of engine intake air, for example by plural turbochargers. While the details of the turbocompounding system have been omitted from FIG. 22, it will be understood that they are substantially similar to those described in connection with the turbocompounding system 30 in the embodiments of FIGS. 1, 18, and 19. Differences in a turbocompounding system employed in connection with the embodiment of FIG. 22 relative to that employed in connection with the embodiments of FIGS. 1, 18, and 19, may include an electric device (similar to first electric device 32 illustrated in FIG. 1) associated with the shaft of one or more of the plural turbochargers. In other words, while the single turbocharger disclosed in connection with the embodiments of FIGS. 1, 18, and 19 may have associated with it a single electric device 32, it is possible to employ a similar electric device, and its accompanying electronics, with any one or more (or even all) of the turbochargers in a multiple turbocharger system. In this way, energy may be recovered efficiently in such a multiple turbocharger system. FIG. 22 illustrates an exemplary multi-stage system for pressurizing engine intake air utilizing two turbochargers.

During operation of engine 310, exhaust gases may flow through exhaust system 312, first to a turbine 314 of a turbocharger 315 and then to a turbine 318 of a turbocharger 319. Intake air and or air/fuel mixture may flow through intake system 326, passing first through compressor 320 of turbocharger 319 and thereafter through compressor 316 of turbocharger 315. Compressor 316 may be driven by turbine 314 via shaft 317, while compressor 320 may be driven by turbine 318 via shaft 321. A cooling unit in the form of intercooler 322 may be positioned between compressor 320 and compressor 316 to cool air and/or air/fuel mixture pressurized by compressor 320 and thereby increase its density. A cooling unit in the form of aftercooler 324 may be positioned between compressor 316 and engine 310 to cool air and/or air/fuel mixture pressurized by compressor 316 and further increase the density of the air and/or fuel/air mixture.

Compressor 320 may compress intake air from ambient atmospheric pressure to approximately 2-3 atmospheres, for example. In doing so, the air may be heated from an ambient temperature of, for example, 68° F. up to approximately 313° F. Intercooler 322 may then cool the air to approximately 140° F. and increase its density. The compressed and cooled air may then enter compressor 316 and be compressed further to approximately 4-6 atmospheres, for example. After compression within compressor 316 raises temperature of the intake air once again, aftercooler 324 may reduce the temperature of the intake air to less than or equal to 200° F. Thus, intake air may be pressurized to at least 5 atmospheres, or even 6 atmospheres, and cooled to as low as 200° F. or below so as to produce pressurized air or a pressurized mixture of fuel and air which is subsequently captured within the combustion chambers in engine 310.

Referring still to the exemplary embodiment diagrammatically illustrated in FIG. 22, emissions control and fuel efficiency may be enhanced by employing various expedients. For example, a system for controllably recirculating a portion of the engine exhaust gases may be employed. While such a system may be recognized by different designations in the art, for purposes of simplifying this description, the term EGR (exhaust gas recirculation) will be employed. EGR system 340 may be configured to extract a portion of the engine exhaust gases from exhaust system 312, before conveying the exhaust gases through a suitable flowpath 342, and introducing the exhaust gases into the intake system 326.

In the exemplary embodiment of FIG. 22, exhaust gases may be extracted from exhaust system 312 at a relatively high pressure point, designated by arrow 344, between engine 310 and turbine 314, and introduced into the intake system at a relatively low pressure point, designated by arrow 346, upstream of compressor 320, resulting in a mixture in intake system 326 including air and recirculated exhaust gases. In such an arrangement, the turbochargers 319 and 315 compress the air and exhaust gas mixture and the intercooler 322 and aftercooler 324 cool the air and exhaust gas mixture before the cooled, compressed mixture is supplied to the combustion chamber of the engine 310 via an intake port. Extraction of exhaust gases may alternatively occur at other points in the exhaust system 312, such as the points indicated by arrows 344′ (between the two turbochargers) and 344″ (downstream of turbine 318).

Such a system, wherein exhaust gases to be recirculated in an EGR system are introduced at a relatively low pressure point upstream of any precompression of intake air, is sometimes referred to in the art as a “low pressure” EGR system. A suitable flow control device 345 (e.g., valve) may be provided to control the amount of exhaust gases extracted from exhaust system 312 and, thereby, vary the proportion of exhaust gas and air in the mixture that is compressed and cooled before introduction in the combustion chamber of engine 310. Flow control device 345 may be controlled by a suitable controller (e.g., system controller 36 in FIG. 1 and in FIG. 20 or a similar controller) in response to a monitored condition such as engine load or engine speed, for example. Subsequent to extraction of exhaust gases at point 344 and before introduction into intake system 326 at point 346, the hot exhaust gases may be cooled by a cooler 348. One disclosure of a prior art system involving extraction of exhaust gases from an exhaust system and introduction of the exhaust gases into an air intake system upstream of two stages of compression (low pressure EGR) is described in U.S. Pat. No. 5,617,726 issued to Sheridan et al. The Sheridan et al. patent illustrates, in FIGS. 5-7 thereof, different points of extraction of exhaust gases. The Sheridan et al. patent also discloses that the extracted exhaust gases may be passed through a cooler (19) before being introduced into the intake system for the engine (1). Additionally, after passing through two stages of pressurization (8, 6), the air and exhaust gas mixture passes through a cooler (17) in Sheridan et al.

Referring still to FIG. 22, another expedient that may be employed in the interest of fuel efficiency and enhanced combustion is represented diagrammatically by the arrow 350. As has been discussed in connection with the description of engine cylinder 219 of FIG. 20, fuel may be admitted to the cylinders of engine 310 by way of one or more injectors (such as fuel injector assembly 240 in FIG. 20) situated so as to inject fuel directly into the combustion chamber. Alternative, or additionally, fuel may be introduced into intake system 326 at a point upstream of one or more of compressors 316 or 320. For example, fuel may be introduced upstream of compressor 320 at the point designated diagrammatically by arrow 350. As exemplified by the embodiment illustrated in FIG. 22, the expedient of introducing fuel upstream of precompression of the intake air may be employed in combination with the expedient of low pressure EGR, previously discussed. One prior art disclosure of both the introduction of fuel upstream of a compressor for intake air and the use of low pressure EGR is U.S. Pat. No. 5,357,936 to Hitomi et al. The Hitomi et al. patent illustrates (in FIG. 3 of the patent) a fuel injector (56) upstream of the compressor (represented by supercharger (32)), and a low pressure EGR system including EGR cooler (72) and a point of introduction of the low pressure EGR upstream of supercharger (32).

### INDUSTRIAL APPLICABILITY

The TC system 30 and overall control system 14 provide a high degree of control, and many options, for turbocompounding engine 10, 310. The system can be visualized as having three control loops. A loop to control the amount of electrical power being produced by generator 32 is illustrated by voltage loop 140. Another loop, represented by current loop 122, controls the amount of electrical power consumed by motor 34. A third loop controls the amount of power being recovered through TC system 30. In the exemplary description for FIG. 18, this third loop is represented by a primary or first feedback loop 90 and the additional feedback loops 98, 108 described. It is this third loop that regulates engine 10 and overall system 12 to a desired operating point. This control system architecture is also applicable when electrical devices 32, 34 act as a motor and generator, respectively. Operational differences between the two modes can be achieved by running different sections within the software of the control system.

As will be appreciated, another embodiment may have current loop 122 be instead used to control voltage. Voltage loop 140 would then be used to control current. Further, it is desirable to avoid interactions between loops 122, 140, as well as first 90 (and second 98 and third 108) feedback loops. This is accomplished by watching the time constants for the loops. In a preferred embodiment this would be accomplished by having the generator voltage loop have the fastest time constant, followed by the motor current loop 122 and then the feedback loops 90, 98, 108.

Fuel efficiency, emissions control, and power output may be effectively managed and balanced by employing the turbocompounding system, described in connection with FIGS. 1-19, in an engine that also employs variable late closing Miller Cycle features along with low pressure EGR and multi-stage fuel injection and/or compressing and cooling a fuel/air mixture prior to capturing the fuel/air mixture in an engine cylinder. In one exemplary embodiment, fuel may be admitted or injected into the intake air upstream of one or more turbocharger compressors to form a fuel/air mixture which is pressurized and cooled to form a pressurized, temperature-controlled fuel/air mixture. This fuel/air mixture may then be introduced through an inlet port into the combustion chamber of an engine cylinder for combustion during one or more (e.g., each) four-stroke engine cycles, including four-stroke engine cycles such as those shown in FIG. 21 that involve an intake valve being open during a majority portion of the compression stroke and closing very late in the compression stroke.

In another exemplary embodiment, exhaust gases may be controllably extracted from the exhaust system and introduced at a point upstream of one or more turbocharger compressors to form an air/exhaust gas mixture which is pressurized and cooled prior to being introduced one or more through an inlet port into the combustion chamber of an engine cylinder for combustion during one or more four-stroke engine cycles, including those involving the intake valve remaining open during a majority portion of the compression stroke and closing very late in the compression stroke.

Thus, it will be appreciated that the disclosed systems, steps, and apparatus provide a great deal of flexibility to control an engine having turbocompounding. This control enables the recovery of energy from operation of the engine, with the added capability, where desired, to keep the engine within set limits of performance or other requirements. Furthermore, combining the Miller Cycle related feature of maintaining open at least one intake valve during at least a portion of the intake stroke and beyond the end of the intake stroke and into the compression stroke and during a majority portion of the compression stroke with the disclosed turbocompounding system enables further enhancement of engine performance. Moreover, engine performance may be enhanced even further by the addition of one or more of variable intake valve closing, multi-stage fuel injection, dual stage turbocharging, pre-compression of an air/fuel mixture, and low pressure EGR. Additionally, while FIG. 22 illustrates two turbochargers employed to yield two stages of pressurization, it will be understood that more than two stages of pressurization are contemplated to be within the scope of this disclosure. For example, three stages of turbocharging and pressurization of intake air may offer even greater flexibility and control. One prior art example of the use of three stages of turbocharging is disclosed in U.S. Pat. No. 4,930,315 issued to Kanesaka. See, for example, FIG. 7 of the Kanesaka patent.

The embodiments illustrated above and in the drawings have been shown by way of example. There is no intent to limit the disclosure to the exemplary forms described. All modifications, equivalents and alternatives falling within the scope of the appended claims are to be covered.

What is claimed is:

1. A turbocompound system for an engine having at least one turbocharger, at least one first electric machine rotatably coupled to the at least one turbocharger, and a second electric machine rotatably coupled to the engine, comprising:
a control system configured to enable recovery of energy through operation of the at least one first electric machine and the second electric machine.

2. The turbocompound system of claim 1, wherein the control system receives at least two signals selected from engine exhaust temperature, turbocharger speed, and engine boost pressure.

3. The turbocompound system of claim 1, wherein an electrical bus connects the at least one first electric machine and the second electric machine, and wherein the control system regulates one of the voltage and current on the bus.

4. The turbocompound system of claim 1, wherein
the at least one first electric machine is configured to act as a motor or as a generator;
the second electric machine is configured to act as a motor or a generator; and
wherein the control system regulates when the second electric machine acts as a generator.

5. The turbocompound system of claim 4 wherein the control system regulates the second electric machine to act as a generator responsive to a lag condition of the at least one turbocharger.

6. An engine comprising:
the turbocompound system of claim 1;
a chamber with an intake port associated therewith;
a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke;
at least one cooler cooling air compressed by the at least one turbocharger and supplying the cooled, pressurized air to the intake port associated with the chamber; and
an intake valve movable to open and close the intake port;
wherein the engine is configured so that the intake valve opens the intake port,
allows cooled, pressurized air to flow through the intake port and into the chamber during the intake stroke,
maintains open the intake port during the intake stroke and beyond the end of the intake stroke and into the compression stroke and during a majority portion of the compression stroke, and
then closes the intake port during travel of the piston to capture in the chamber a cooled, compressed charge comprising the cooled pressurized air.

7. The engine of claim 6, further including a fuel delivery system delivering fuel into the chamber after the cooled compressed charge is captured in the chamber, wherein the engine ignites a mixture of the fuel and air within the chamber.

8. The engine of claim 7, wherein the fuel delivery system supplies pressurized fuel directly to the chamber during a portion of the compression stroke and during a portion of the expansion stroke.

9. The engine of claim 6, further including an exhaust gas recirculation system forming a mixture including air and recirculated exhaust gas, wherein the at least one turbocharger compresses the air and exhaust gas mixture and the at least one cooler cools the air and exhaust gas mixture before supplying the cooled, compressed mixture to the chamber via the intake port.

10. The engine of claim 9, wherein the exhaust gas recirculation system varies the proportion of exhaust gas and air in the mixture in response to at least one monitored condition and cools the recirculated exhaust gas prior to mixing the recirculated exhaust gas and the air.

11. The engine of claim 6, further including a variable intake valve closing system varying timing of the intake valve.

12. The engine of claim 11, wherein the variable intake valve closing system closes the intake valve at a first crank angle during one four stroke cycle of the piston and at a second crank angle during another four stroke cycle of the piston, the first crank angle being different from the second crank angle.

13. The engine of claim 6, wherein the intake port is maintained open for at least 65% of the compression stroke.

14. The engine of claim 6, wherein the intake port is maintained open for at least 80% of the compression stroke.

15. The engine of claim 6, wherein the at least one turbocharger provides a first stage of compression for air and the at least one cooler provides a first stage of cooling, and wherein the engine includes a second stage of compression and a second stage of cooling.

16. The engine of claim 6, wherein the air is compressed outside the chamber to at least 5 atmospheres, and then cooled to a temperature less than or equal to 200 degrees F.

17. The engine of claim 6, wherein the engine is a diesel-fueled, compression ignition engine.

18. The engine of claim 6, wherein the engine is either a gasoline-fueled engine or a natural gas-fueled engine, and wherein the engine is spark ignited.

19. The engine of claim 6, wherein the intake port is maintained open for a majority portion of the compression stroke during high load operation of the engine.

20. A method of operating a turbocompound system for an engine having at least one turbocharger, the turbocompound system having at least one first electric machine generating electrical power in response to rotation of the at least one turbocharger, a second electric machine driving the engine in response to electrical power generated by the at least one first electric machine, and an electrical bus connecting the at least one first electric machine and the second electric machine, comprising:
controlling operating of the turbocompound system to enable recovery of energy through operation of the at least one first electric machine and the second electric machine.

21. A method of operating a four-stroke, internal combustion engine including a chamber with an intake port associated therewith, and a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke, the method comprising:
compressing air outside the chamber by operating a turbocompound system in accordance with the method of claim 20;
cooling air outside the chamber;
supplying the cooled, pressurized air to the intake port associated with the chamber;
opening the intake port;
allowing cooled, pressurized air to flow through the intake port and into the chamber during the intake stroke;
maintaining open the intake port during the intake stroke and beyond the end of the intake stroke and into the compression stroke and during a majority portion of the compression stroke; and
after the maintaining, closing the intake port during travel of the piston to capture in the chamber a cooled, compressed charge comprising the cooled pressurized air.

22. The method of claim 21, further including delivering fuel into the chamber after the cooled compressed charge is captured in the chamber, and igniting a mixture of the fuel and air within the chamber.

23. The method of claim 22, further including supplying pressurized fuel directly to the chamber during a portion of the compression stroke and during a portion of the expansion stroke.

24. The method of claim 21, further including forming a mixture including air and recirculated exhaust gas, and compressing and cooling the air and exhaust gas mixture before supplying the cooled, compressed mixture to the chamber via the intake port.

25. The method of claim 24, further including varying the proportion of exhaust gas and air in the mixture in response to at least one monitored condition and cooling the recirculated exhaust gas prior to mixing the recirculated exhaust gas and the air.

26. The method of claim 21, further including varying timing of the intake valve.

27. The method of claim 26 wherein varying the timing includes closing the intake valve at a first crank angle during one four stroke cycle of the piston and at a second crank angle during another four stroke cycle of the piston, the first crank angle being different from the second crank angle.

28. The method of claim 21, wherein the intake port is maintained open for at least 65% of the compression stroke.

29. The method of claim 21, wherein the intake port is maintained open for at least 80% of the compression stroke.

30. The method of claim 21, wherein the compressing includes a first stage of pressurization and a second stage of pressurization, and wherein the cooling includes a first stage of cooling and a second stage of cooling.

31. The method of claim 21, wherein the air is compressed outside the chamber to at least 5 atmospheres, and then cooled to a temperature less than or equal to 200 degrees F.

32. The method of claim 21, wherein the engine is a diesel-fueled, compression ignition engine.

33. The method of claim 21, wherein the engine is either a gasoline-fueled engine or a natural gas-fueled engine, and wherein the engine is spark ignited.

34. The method of claim 21, wherein the intake port is maintained open for a majority portion of the compression stroke during high load operation of the engine.
